(19) United States
(12) Patent Application Publication
(10) Pub. No.: US 2004/0178595 A1
(43) Pub. Date: Sep. 16, 2004

(54) Wheel adjustment system for a go-kart

(76) Inventors: Joseph R. Coggin, Stowe, OH (US); Robert S. Nervo II, Stowe, OH (US)

Correspondence Address: Howard M. Cohn, Suite 220, 21625 Chagrin Blvd., Cleveland, OH, 44122, US

(21) Appl. No.: 10/389,035

(22) Filed: Mar. 14, 2003

(51) Int. Cl. B60G 7/02

(52) U.S. Cl. 280/86.758

(57) ABSTRACT

Apparatus and method for adjusting camber, caster, fore-aft and lateral kingpin position for a go-kart wheel. The kingpin is mounted in a bracket providing camber and caster adjustment, and the bracket is adjustably attached to a fore-aft oriented bar on the go-kart. A flange slides on the bar and rotatingly mates with the bracket, for caster rotation about holes in the flange and bracket that are linked by a cylindrical pill having a collar. Holes through a plurality of pills are off center by various distances, and threaded holes are regularly spaced along the mounting bar. Bolts through selected holes in selected pills and screwed into selected threaded holes attach the pill to the bar with a selected fore-aft adjustment, the collar holding the flange. A selected number of spacers adjust lateral position when inserted between flange and bracket, having a recess and hub to mimic the rotatable mating of the flange, pill, and bracket. Bolts through arcuate holes rotatably hold the bracket, spacers and flange together.

### TECHNICAL FIELD OF THE INVENTION

The present invention relates to vehicular wheel adjustment systems and, more particularly, to a system for making wheel adjustments including camber, caster, wheel base and track width, and most particularly for said adjustment systems for small recreational or racing vehicles such as go-karts.

### BACKGROUND OF THE INVENTION

Go-karts (a.k.a. “go carts”, “racing carts”, or simply “karts”) have evolved from homemade contraptions powered by lawnmower engines to extremely sophisticated commercially manufactured recreational and racing vehicles. U.S. Pat. No. 5,265,690 (Amundsen et al.; 1993), discloses a vehicle frame exemplary of commercial go-karts.

Particularly when used for racing, go-karts require precision steering mechanisms often having many of the same adjustment capabilities of automobiles, such as the camber and caster adjustments performed in automotive wheel alignment. Those who race go-karts on small circular or oval tracks may find performance advantages from other adjustments to the wheel positioning. For example, it is well known in the art to provide a “lead” to one of the front tires, such that one of the front tires is mounted forward of (i.e., leading) the other front tire. See, for example, the 2001 Spring Catalog for the Phantom Racing Chassis of Wiggins Kart Shop, Inc (China Grove, N.C.). On page 10 of said catalog, it states that the “racer can choose from two different lead settings.” It is an object of the present invention to provide significantly more versatile lead (i.e., fore-aft) adjustability in a wheel adjustment system that is both precise and easy to use.

Regarding fore-aft adjustment of wheels, U.S. Pat. No. 5,737,801 (Flood; 1998), discloses an insert adapted to be positioned within an elongated channel member forming a C-shaped channel, the insert having a width to be conformably received in said channel member either for longitudinal movement therein or to be positioned therein to receive the axle of a wheel. FIGS. 16 and 18 show an insert (91) slidably received within a channel (96) and held in a given longitudinal adjustment position by bolts (99) passing through washers (101), through elongated holes (102) in the channel, and being screwed into threaded holes (98) in the insert. Compression of the washers against the channel by the screwed-in bolts prevents movement of the insert after adjustment to the desired longitudinal position.

Further regarding fore-aft adjustment of wheels, U.S. Pat. No. 5,428,866 (Aschow; 1995), discloses an extruded mounting plate for a detachable heavy duty caster comprising an extrusion (4) shaped to form a flat bottom plate with raised parallel sides each including an overhanging flange (3). A base plate (32) of the caster slides into the extrusion, stopping against a protruding head of an attachment pin (5), and being held in a single longitudinal position within the extrusion by the attachment pin head (5) on the one end and a spring loaded button (7) at the other end.

Regarding both fore-aft and lateral spacing adjustment of wheels, U.S. Pat. No. 5,943,734 (Pearce; 1999), discloses a multi-adjustable wheelchair with adjustability features including wheelchair rear axle fore-aft position adjustment and wheelchair frame width adjustment. Wheelchair frame width adjustment is accomplished by providing spacers (blocks 201) between the wheels and the frame. FIGS. 2a-2c show a plurality of blocks (201) installed on a wheelchair frame (205) by a plurality of bolts (208) projecting through fastener holes or attachment bosses (205) that pass through the center of protruding pegs (204) on one side of the block and peg receptacles (210) on the other side of the block. The peg receptacles (210) are recessed to accept the pegs (204). Protrusion of pegs (204) into blocks (201) and frame (206) combined with bolts (208) or other attachment means provides a width-adjustment feature which is rigid and secure from all directions. Fore-aft position adjustment of the rear wheel is accomplished by means of a rotatable member (301 in FIGS. 3a-3b) comprising an elongated lug receptacle (308) to permit sliding adjustment of lug (306) within receptacle (308). The lug (306) includes an axle receptacle (307) for receiving an axle on which a wheelchair wheel may rotate. A repeating circumferential pattern of pegs (304), each with its own center hole (305) for receiving a bolt, facilitate firm engagement of the rotatable member (301) with blocks (201) and/or to a wheelchair frame having receptacles for the pegs (304) of either the blocks (201) or the rotatable member (301). This permits stacking or nesting of the rotatable member (301) with a plurality of blocks (210), and also ensures that the rotatable member, blocks, and frame will be rigidly engaged to each other and will provide adequate structural rigidity for supporting a wheelchair axle. Another embodiment of the rotatable member (301 in FIG. 3c-3d) includes a plurality of lug receptacles (308) to permit discrete adjustment of lug (306) within one of receptacles (308). The lug (306) can be attached inside a lug receptacle (308) by any attaching means such as the preferred means of threading it into a nut. The lug (306) can be loosened and slid or inserted within a lug receptacle (308) and reattached at any location therein, providing infinite or discrete adjustment with the confines of the receptacle (308). The rotatable member (301) can be rotated to a plurality of discrete rotational positions corresponding to rotational positions wherein, for example, the pegs (304) of the rotatable member (301) engage with the receptacles (210) of the blocks (201). Depending on the rotational position of the rotatable member (301) with respect to the wheelchair frame, this adjustment may bring about a forward/rearward adjustment or a vertical adjustment of the wheelchair axle with respect to the wheelchair frame, or a combination of the two.

It is an object of the present invention to provide wheel track width adjustment in a way that also allows non-discreet rotation of the adjustment means for the purpose of adjusting caster of the wheel.

It is a further object of the present invention to provide multi-position fore-aft adjustability in a wheel adjustment system that also provides caster, camber, and track width adjustment ability. It is a further object that said wheel adjustment system be precise, rugged, durable and easy to use.

It is a further object of the present invention to provide independent adjustability of fore-aft position, lateral position, caster and camber in a wheel adjustment system for a steerable wheel.

### BRIEF SUMMARY OF THE INVENTION

According to the invention, a wheel adjustment system is provided for a go-kart having a kingpin about which a wheel steeringly rotates in response to steering input, the wheel adjustment system comprising: a mounting bar fixedly attached to a frame of the go-kart such that a longitudinal axis of the mounting bar is oriented in a fore-aft direction relative to the frame; a kingpin holder comprising a spindle bracket for holding the kingpin, and a sliding flange for slidably engaging with the mounting bar; one or more openings regularly spaced along the longitudinal axis of the mounting bar; at least one through hole longitudinally spaced by offset distances along the sliding flange; and fore-aft securing elements extending through selected ones of the at least one through hole and into selected ones of the one or more openings for attaching the spindle bracket to the frame with a selected fore-aft adjustment distance.

More specifically according to the invention, the wheel adjustment system further comprises: a square U-shaped, inward opening channel on the sliding flange; an inward facing first surface on the spindle bracket mating with a corresponding outward facing second surface on the sliding flange; a circular caster pivot hole in the first surface, and a circular pill receiving hole in the second surface; an adjustment pill that fits into the pill receiving hole and rotatingly fits into the caster pivot hole when the first surface and the second surface are held together, for allowing only rotational movement of the spindle bracket relative to the sliding flange; and removable attachment means for holding the first surface and the second surface together; wherein: the at least one through holes are in the adjustment pill such that each of the at least one through holes is parallel to an axis of revolution of the adjustment pill, and is offset from the axis of revolution by an offset distance; the openings are threaded holes; and the fore-aft securing elements are bolts that pass through the through holes and screw into the threaded holes.

According to the invention, the wheel adjustment system further comprises: two through holes having equal offset distances on diametrically opposing sides of the axis of revolution. Preferably, the threaded holes are regularly spaced at twice the equal offset distance.

According to the invention, the wheel adjustment system further comprises: a plurality of adjustment pills, each having a different offset distance; and a collar around the adjustment pill for holding the sliding flange to the mounting bar.

According to the invention, the wheel adjustment system further comprises: a plurality of track width spacers selectable for providing selected discrete increases in track width when a selected quantity of the plurality of track width spacers is positioned between the first surface and the second surface, wherein each one of the plurality of track width spacers comprises: an outward facing third surface that mates with the first surface; an inward facing fourth surface that mates with the second surface; in the fourth surface, a circular recess dimensioned such that the adjustment pill fits therein; and on the third surface, a protruding hub that rotatingly fits into the caster pivot hole.

According to the invention, the removable attachment means comprises attachment bolts that screw into either the spindle bracket or the sliding flange; and arcuate oblong through holes for the attachment bolts are provided for allowing the spindle bracket to rotate about the caster pivot hole to adjust a caster angle.

According to the invention, camber adjustment components are provided comprising: a top arm of the spindle bracket comprising: an oblong camber adjustment hole for tiltingly receiving the kingpin, and serrations regularly spaced with a pitch on top of the top arm around the camber adjustment hole; a nominally square camber block comprising: four sides, a bottom surface having an orderly array of four-sided pyramids that interlock with the serrations, and a central kingpin hole for receiving the kingpin; such that: the pyramids are defined by a first set of parallel valleys that cross orthogonally from a first camber block side to an opposing third camber block side, and by a second set of parallel valleys that cross orthogonally from a second camber block side to an opposing fourth camber block side; the first set of parallel valleys is offset from a center of the kingpin hole by a first offset distance that is a first fraction of the pitch; the second set of parallel valleys is offset from the center of the kingpin hole by a second offset distance that is a second fraction of the pitch; and the second offset distance has a different magnitude than the first offset distance for enabling a different increment of camber angle adjustment when each of the four camber block sides is turned to face aftward.

According to the invention, a wheel adjustment system is provided for a go-kart having a kingpin about which a wheel steeringly rotates in response to steering input, the wheel adjustment system comprising: a sliding flange attached to a frame of the go-kart; a spindle bracket for holding the kingpin; an inward facing first surface on the spindle bracket mating with a corresponding outward facing second surface on the sliding flange; a plurality of track width spacers, each comprising: an outward facing third surface that mates with the first surface; and an inward facing fourth surface that mates with the second surface; and removable attachment means for holding together the sliding flange, a selected quantity of the plurality of track width spacers, and the spindle bracket; such that: the selected quantity of the plurality of track width spacers can be positioned between the first surface and the second surface for providing selected discrete increases in track width while maintaining the position of the kingpin in relationship to the wheel.

More specifically according to the invention, the wheel adjustment system further comprises: a circular caster pivot hole in the first surface, and a circular pill receiving bole in the second surface; an adjustment pill that fits into the pill receiving hole and rotatingly fits into the caster pivot hole when the first surface and the second surface are held together, for allowing only rotational movement of the spindle bracket relative to the sliding flange; in the fourth surface, a circular recess dimensioned such that the adjustment pill fits therein; and on the third surface, a protruding hub that rotatingly fits into the caster pivot hole.

According to the invention, the wheel adjustment system further comprises: a mounting bar fixedly attached to a frame of the go-kart such that a longitudinal axis of the mounting bar is oriented in a fore-aft direction relative to the frame; a square U-shaped channel in the sliding flange, the channel opening inward for slidably engaging with the mounting bar, thereby providing attachment of the sliding flange to the frame; at least one through hole in the adjustment pill wherein each of the at least one through holes is parallel to an axis of revolution of the adjustment pill, and is offset from the axis of revolution by an offset distance; one or more threaded holes regularly spaced along the longitudinal axis of the mounting bar; and fore-aft securing bolts for passing through selected ones of the at least one through holes and for screwing into selected ones of the one or more threaded holes, thereby attaching the spindle bracket to the frame with a selected fore-aft adjustment distance.

According to the invention, the wheel adjustment system further comprises: two through holes having equal offset distances on diametrically opposing sides of the axis of revolution. Preferably, the threaded holes are regularly spaced at twice the equal offset distance.

According to the invention, the wheel adjustment system further comprises: a plurality of adjustment pills, each having a different offset distance; and a collar around the adjustment pill for holding the sliding flange to the mounting bar.

According to the invention, the removable attachment means comprises attachment bolts that screw into either the spindle bracket or the sliding flange; and arcuate oblong through holes for the attachment bolts are provided for allowing the spindle bracket to rotate about the caster pivot hole to adjust a caster angle. Preferably, camber adjustment components are provided comprising: a top arm of the spindle bracket comprising: an oblong camber adjustment hole for tiltingly receiving the kingpin, and serrations regularly spaced with a pitch on top of the top arm around the camber adjustment hole; a nominally square camber block comprising: four sides, a bottom surface having an orderly array of four-sided pyramids that interlock with the serrations, and a central kingpin hole for receiving the kingpin; such that: the pyramids are defined by a first set of parallel valleys that cross orthogonally from a first camber block side to an opposing third camber block side, and by a second set of parallel valleys that cross orthogonally from a second camber block side to an opposing fourth camber block side; the first set of parallel valleys is offset from a center of the kingpin hole by a first offset distance that is a first fraction of the pitch; the second set of parallel valleys is offset from the center of the kingpin hole by a second offset distance that is a second fraction of the pitch; and the second offset distance has a different magnitude than the first offset distance for enabling a different increment of camber angle adjustment when each of the four camber block sides is turned to face aftward.

According to the invention, a wheel adjustment system is provided for a go-kart having a kingpin about which a wheel steeringly rotates in response to steering input, the wheel adjustment system comprising: a mounting bar fixedly attached to a frame of the go-kart such that a longitudinal axis of the mounting bar is oriented in a fore-aft direction relative to the frame; a sliding flange for slidably engaging with the mounting bar; a spindle bracket for pivotably holding a kingpin, thereby enabling camber adjustment by selectively pivoting the kingpin in the spindle bracket; an inward facing first surface on the spindle bracket mating with a corresponding outward facing second surface on the sliding flange; a circular caster pivot hole in the first surface; a circular protruding hub on the second surface that rotatingly fits into the caster pivot hole when the first surface and the second surface are held together, for allowing only rotational movement of the spindle bracket relative to the sliding flange, thereby enabling caster adjustment; removable attachment means for holding the first surface and the second surface together; at least one through hole longitudinally spaced by offset distances along the sliding flange; one or more openings regularly spaced along the longitudinal axis of the mounting bar; fore-aft securing elements extending through selected ones of the at least one through hole and into selected ones of the one or more openings for attaching the spindle bracket to the frame with a selected fore-aft adjustment distance; and a plurality of track width spacers for providing selected discrete increases in track width when a selected quantity of the plurality of track width spacers is positioned between the first surface and the second surface for providing selected discrete increases in track width while maintaining the position of the kingpin in relationship to the wheel.

More specifically according to the invention, the sliding flange has a square U-shaped, inward opening channel for slidably engaging with the mounting bar; the circular protruding hub on the second surface is an adjustment pill that fits into a circular pill receiving hole provided in the second surface, and that rotatingly fits into the caster pivot hole when the first surface and the second surface are held together; the at least one through holes are formed in the adjustment pill wherein each of the at least one through holes is parallel to an axis of revolution of the adjustment pill, and is offset from the axis of revolution by an offset distance; each one of the plurality of track width spacers comprises: an outward facing third surface that rotatingly mates with the first surface; and an inward facing fourth surface that mates with the second surface; a circular recess dimensioned such that the adjustment pill fits therein is provided in the fourth surface; a protruding hub that rotatingly fits into the caster pivot hole is provided on the third surface; the openings are threaded holes; and the fore-aft securing elements are bolts that pass through the through holes and screw into the threaded holes.

According to the invention, the removable attachment means comprises attachment bolts that screw into either the spindle bracket or the sliding flange; and arcuate oblong through holes for the attachment bolts are provided for allowing the spindle bracket to rotate about the caster pivot hole to adjust a caster angle. Preferably, camber adjustment components are provided comprising: a top arm of the spindle bracket comprising: an oblong camber adjustment hole for tiltingly receiving the kingpin, and serrations regularly spaced with a pitch on top of the top arm around the camber adjustment hole; a nominally square camber block comprising: four sides, a bottom surface having an orderly array of four-sided pyramids that interlock with the serrations, and a central kingpin hole for receiving the kingpin; such that: the pyramids are defined by a first set of parallel valleys that cross orthogonally from a first camber block side to an opposing third camber block side, and by a second set of parallel valleys that cross orthogonally from a second camber block side to an opposing fourth camber block side; the first set of parallel valleys is offset from a center of the kingpin hole by a first offset distance that is a first fraction of the pitch; the second set of parallel valleys is offset from the center of the kingpin hole by a second offset distance that is a second fraction of the pitch; and the second offset distance has a different magnitude than the first offset distance for enabling a different increment of camber angle adjustment when each of the four camber block sides is turned to face aftward.

According to the invention, the wheel adjustment system further comprises: two through holes having equal offset distances on diametrically opposing sides of the axis of revolution. Preferably the threaded holes are regularly spaced at twice the equal offset distance.

According to the invention, the wheel adjustment system further comprises: a plurality of adjustment pills, each having a different offset distance; and a collar around the adjustment pill for holding the sliding flange to the mounting bar.

According to the invention, a method for independently adjusting camber, caster, fore-aft position and lateral position of a go-kart steered wheel while maintaining a position of a kingpin in relationship to the steered wheel, wherein the steered wheel is rotatingly mounted on a nominally horizontal spindle that rotates about a nominally vertical kingpin in response to steering input, and wherein the kingpin is adjustably mounted in a spindle bracket that is adjustably attached to a frame of the go-kart; the method comprising the steps of: adjusting camber by selectively pivoting the kingpin in the spindle bracket; fixedly attaching a mounting bar to a frame of the go-kart such that a longitudinal axis of the mounting bar is oriented in a fore-aft direction relative to the frame; providing a sliding flange for slidably engaging with the mounting bar; mating an inward facing first surface on the spindle bracket with a corresponding outward facing second surface on the sliding flange; allowing only rotational movement of the spindle bracket relative to the sliding flange by providing a circular caster pivot hole in the first surface, and a circular protruding hub on the second surface that rotatingly fits into the caster pivot hole when the first surface and the second surface are held together, thereby enabling caster adjustment; holding the first surface and the second surface together with removable attachment means; regularly spacing one or more openings along the longitudinal axis of the mounting bar; providing at least one through hole spaced by offset distances along the channel; attaching the spindle bracket to the frame with a selected fore-aft adjustment distance by passing fore-aft securing elements through selected ones of the at least one through holes, and then securing the fore-aft securing elements into selected ones of the one or more openings; and selecting discrete increases in track width by positioning a selected quantity of track width spacers between the first surface and the second surface, wherein the track width spacer comprises: an outward facing third surface that rotatingly mates with the first surface; and an inward facing fourth surface that mates with the second surface.

More specifically according to the invention, the method further comprises the steps of: providing a square U-shaped, inward opening channel in the sliding flange for slidably engaging with the mounting bar; forming the circular protruding hub on the second surface by providing an adjustment pill that fits into a circular pill receiving hole provided in the second surface, and that rotatingly fits into the caster pivot hole when the first surface and the second surface are held together; forming the at least one through holes in the adjustment pill wherein each of the at least one through holes is parallel to an axis of revolution of the adjustment pill, and is offset from the axis of revolution by an offset distance; in the fourth surface, providing a circular recess dimensioned such that the adjustment pill fits therein; on the third surface, providing a protruding hub that rotatingly fits into the caster pivot hole; providing threaded holes for the openings; and for the fore-aft securing elements, providing bolts that pass through the through holes and screw into the threaded holes.

According to the invention, the method further comprises the steps of: providing the removable attachment means by screwing attachment bolts into either the spindle bracket or the sliding flange; and forming arcuate oblong through holes for the attachment bolts thereby allowing the spindle bracket to rotate about the caster pivot hole to adjust a caster angle.

According to the invention, the method further comprises steps for adjusting camber angle, including the steps of: providing a top arm of the spindle bracket comprising: an oblong camber adjustment hole for tiltingly receiving the kingpin, and serrations regularly spaced with a pitch on top of the top arm around the camber adjustment hole; providing a nominally square camber block comprising: four sides, a bottom surface having an orderly array of four-sided pyramids that interlock with the serrations, and a central kingpin hole for receiving the kingpin; defining the pyramids by a first set of parallel valleys that cross orthogonally from a first camber block side to an opposing third camber block side, and by a second set of parallel valleys that cross orthogonally from a second camber block side to an opposing fourth camber block side; offsetting the first set of parallel valleys from a center of the kingpin hole by a first offset distance that is a first fraction of the pitch; offsetting the second set of parallel valleys from the center of the kingpin hole by a second offset distance that is a second fraction of the pitch; and selecting a magnitude for the second offset distance that is different than the magnitude of the first offset distance, thereby enabling a different increment of camber angle adjustment when each of the four camber block sides is turned to face aftward.

Other objects, features and advantages of the invention will become apparent in light of the following description thereof.

### BRIEF DESCRIPTION OF THE DRAWINGS

Reference will be made in detail to preferred embodiments of the invention, examples of which are illustrated in the accompanying drawing figures. The figures are intended to be illustrative, not limiting. Although the invention is generally described in the context of these preferred embodiments, it should be understood that it is not intended to limit the spirit and scope of the invention to these particular embodiments.

Certain elements in selected ones of the drawings may be illustrated not-to-scale, for illustrative clarity. The cross-sectional views, if any, presented herein may be in the form of “slices”, or “near-sighted” cross-sectional views, omitting certain background lines which would otherwise be visible in a true cross-sectional view, for illustrative clarity.

Elements of the figures can be numbered such that similar (including identical) elements may be referred to with similar numbers in a single drawing. For example, each of a plurality of elements collectively referred to as 199 may be referred to individually as 199a, 199b, 199c, etc. Or, related but modified elements may have the same number but are distinguished by primes. For example, 109, 109′, and 109″ are three different elements which are similar or related in some way, but have significant modifications, e.g., a rotating element 109 having a static imbalance versus a different rotating element 109′ of the same design, but having a couple imbalance. Such relationships, if any, between similar elements in the same or different figures will become apparent throughout the specification, including, if applicable, in the claims and abstract.

The structure, operation, and advantages of the present preferred embodiment of the invention will become further apparent upon consideration of the following description taken in conjunction with the accompanying drawings, wherein:

FIG. 1 is an overall view of a go-kart type of vehicle mainly showing a frame having wheel adjustment systems, according to the invention;

FIG. 2 is a perspective view of a spindle assembly, according to the invention;

FIG. 3A is a top view of a preferred embodiment of the wheel adjustment system assembled and adjusted, according to the invention;

FIG. 3B is a cross-sectional view taken along the line 3B-3B in FIG. 3A, of the wheel adjustment system of FIG. 3A, according to the invention;

FIG. 3C is a graphic representation of adjustments that are easily made with the wheel adjustment system, according to the invention;

FIG. 4A is a bottom view of a camber block portion of the wheel adjustment system, according to the invention;

FIG. 4B is a side view of a camber block portion of the wheel adjustment system, according to the invention;

FIG. 4C is a side view of a kingpin portion of the wheel adjustment system, according to the invention;

FIG. 5A is a view of the bottom of a spindle bracket portion of the wheel adjustment system, according to the invention;

FIG. 5B is a view of the outward side of a spindle bracket portion of the wheel adjustment system, according to the invention;

FIG. 5C is a view of the top of a spindle bracket portion of the wheel adjustment system, according to the invention;

FIG. 5D is a view of the aft side of a spindle bracket portion of the wheel adjustment system, according to the invention;

FIG. 6A is a view of the outward side of a sliding flange portion of the wheel adjustment system, according to the invention;

FIG. 6B is a view of the inward side of a sliding flange portion of the wheel adjustment system, according to the invention;

FIG. 6C is a cross-sectional view taken along the line 6C-6C of FIG. 6B, of a sliding flange portion of the wheel adjustment system, according to the invention;

FIG. 7 is a view of an outward side surface of a mounting bar portion of the wheel adjustment system, according to the invention;

FIG. 8A is a view of an outward side of a first embodiment of an adjustment pill portion of the wheel adjustment system, according to the invention;

FIG. 8B is a view of an outward side of a second embodiment of an adjustment pill portion of the wheel adjustment system, according to the invention;

FIG. 8C is a view of an outward side of a third embodiment of an adjustment pill portion of the wheel adjustment system, according to the invention;

FIG. 8D is a view of an outward side of a fourth embodiment of an adjustment pill portion of the wheel adjustment system, according to the invention;

FIG. 8E is a top view of a generic adjustment pill portion of the wheel adjustment system, according to the invention;

FIG. 9A is a view of the inward side of a track width spacer portion of the wheel adjustment system, according to the invention;

FIG. 9B is a view of the outward side of a track width spacer portion of the wheel adjustment system, according to the invention;

FIG. 9C is a cross-sectional view taken along the line 9C-9C of FIG. 9B, of a track width spacer portion of the wheel adjustment system, according to the invention; and

FIGS. 10A, 10B, and 10C are examples that illustrate a method of fore-aft (wheelbase) adjustment utilizing the wheel adjustment system, according to the invention.

### DEFINITIONS

“Aft” refers to the rearward longitudinal direction, i.e., toward the back or rear of a vehicle frame upon which wheels are mounted. “Aft”, “rear”, and “back” may be used interchangeably. For wheel adjustments, a rearward direction is negative.

“Camber” is the angular tilt of a wheel in a lateral direction relative to vertical being zero degrees of camber. A wheel tilting outward at the top (laterally away from the vehicle frame) has positive camber; inward at the top is negative camber. If the kingpin is perpendicular to an axis of revolution of the wheel, then the camber angle of the wheel will equal the camber angle of the kingpin.

“Caster” is the angular fore-aft tilt of the kingpin at the top, measured in degrees from a vertical reference. Forward tilt is negative caster; backward (aft) tilt is positive caster.

“Fore” refers to a forward longitudinal direction, i.e., toward the front of a vehicle frame upon which wheels are mounted. “Fore”, “forward”, and “front” may be used interchangeably. For wheel adjustments, a forward direction is positive.

“Kingpin” is a nominally vertical rod that provides a steering axis about which a front tire is rotated in response to steering input.

“Lateral” refers to a linear, horizontal sideways direction relative to a vehicle frame whereupon wheels are mounted on the sides of the frame, typically with one steered wheel on either side toward the front of the frame, and one fixed wheel on either side toward the back of the frame. The lateral direction is perpendicular to the longitudinal direction. A lateral direction away from the frame is “outward”; laterally toward the frame is “inward”.

“Left” and “Right” are lateral directions determined when facing forward.

“Longitudinal” refers to a linear horizontal direction parallel to a straight-ahead path of a vehicle upon which wheels are mounted.

“Track width” is a lateral distance between steered (front) wheels at the centers of their tire contact area on the ground.

“Wheel adjustment” (a.k.a. alignment) most often includes tilting the kingpin laterally (camber) and/or longitudinally (caster), and can also include wheel base adjustment (linear fore-aft) and/or wheel track width adjustment (linear lateral).

“Wheel base” is a longitudinal distance between front and rear wheels at the centers of their tire contact area on the ground, with the steered (front) wheel steered to roll along a straight-ahead path. Wheel base can also be measured between the centers of the front and rear axles. Wheel base must be measured separately on each side of the vehicle.

### DETAILED DESCRIPTION OF THE INVENTION

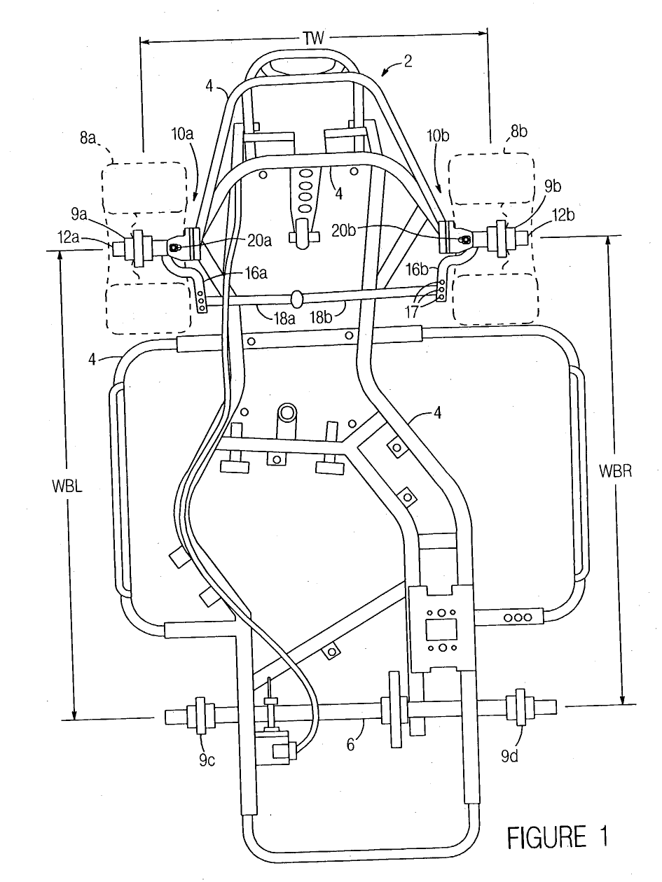

A preferred embodiment of a go-kart 2 type of vehicle is illustrated in FIG. 1 that mainly shows a frame 4 (chassis) having two inventive wheel adjustment systems 10a, 10b (collectively referred to as 10) mounted thereon. The go-kart 2 has a solid rear axle 6 (“fixed”, i.e., not steerable) that is turned by a motor (not shown) in order to drive the go-kart 2. Front tire/wheel assemblies 8a, 8b (shown in phantom outline, all tire/wheel assemblies being collectively referred to as 8) are used for steering the go-kart 2, and are therefore mounted on separate steerable axles or spindles 12a, 12b (collectively referred to as 12). Tire/wheel assemblies 8 are mounted on the spindles 12 and rear axle 6 by means of wheel hubs 9a, 9b, 9c, 9d (collectively referred to as 9), wherein the wheel hubs 9 are attached on the spindles 12 and rear axle 6. A right side wheelbase is indicated by the dimension WBR, and a left side wheelbase is indicated by the dimension WBL. To provide a commonly desired “lead” on the front right tire/wheel assembly 8b, for example, the right wheel adjustment system 10b can be adjusted to increase the right side wheelbase WBR, and/or the left wheel adjustment system 10a can be adjusted to decrease the left side wheelbase WBL. The inventive wheel adjustment system 10 provides a great deal of flexibility in making lead adjustments to suit varying racetrack conditions, whereas the prior art typically built a fixed lead amount into a frame, or at best allowed adjustment between two possible wheelbase dimensions.

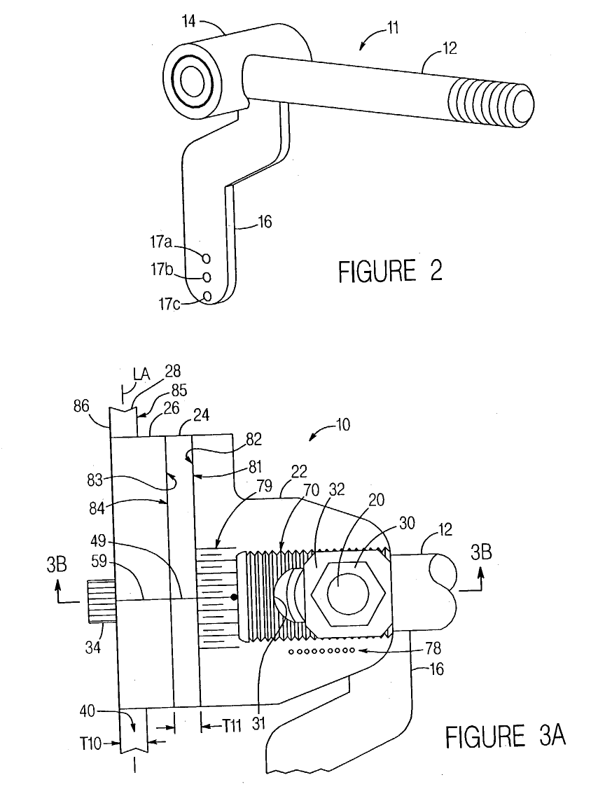

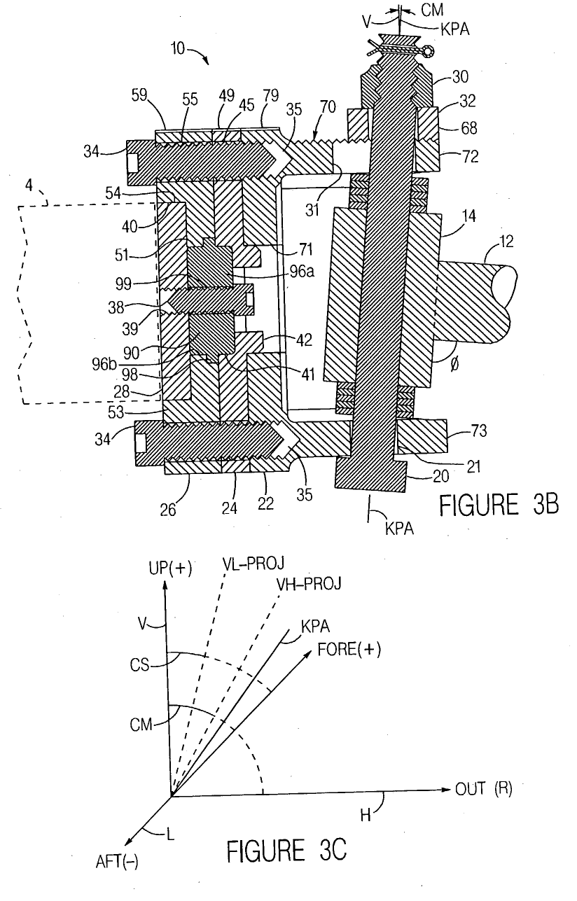

Steering input from a steering wheel (not shown) is transmitted via steering rods 18a, 18b to spindle arms 16a, 16b (collectively referred to as 16) and thence to the spindles 12, thereby causing each spindle 12 to rotate about a kingpin 20a, 20b (collectively referred to as 20) in response to the steering input. FIG. 2 shows a representative spindle assembly 11 comprising nominally mutually orthogonal elements of the spindle 12, the spindle arm 16, and a kingpin hub 14. The kingpin hub 14 coaxially mounts on the kingpin 20 (see FIG. 3B) such that it can freely rotate about the kingpin 20 in response to steering input. Steering rod attachment holes 17a, 17b, 17c (collectively referred to as 17) are provided in the spindle arm 16 for adjustable attachment to the steering rod 18. The spindle arm 16 is commonly attached to the spindle at somewhat non-orthogonal angles as needed to fit within the tight confines of a front end steering and suspension assembly. As best viewed in FIG. 3B, the spindle 12 can be attached to the kingpin hub 14 at a spindle to kingpin hub angle φ that may be non-orthogonal, but the difference between the angle φ and ninety degrees will constitute a preset camber for a tire/wheel assembly 8 mounted on the spindle 12 (assuming a vertical mounting of the wheel adjustment system 10 on the frame 4). For the sake of simplicity, the present description will assume that the spindle to kingpin hub angle φ is ninety degrees, so that the kingpin 20 will be parallel to the tire/wheel assembly 8, and thus the lateral tilt of the kingpin 20 (kingpin inclination) will be equal to the camber of the tire/wheel assembly 8.

Referring again to FIG. 1, a track width for the front tire/wheel assemblies 8a, 8b is indicated by the dimension TW. To vary the track width TW, the inventive right wheel adjustment system 10b can be adjusted to move the right tire/wheel assembly 8b in and out, and/or the left wheel adjustment system 10a can be adjusted to independently move the left tire/wheel assembly 8a in and out. Prior art adjustment systems typically moved the tire/wheel assembly 8 laterally relative to the kingpin 20, e.g., by repositioning the hub 9 on the spindle 12. It is well known in the relevant arts that this causes undesirable effects on the steering characteristics of a vehicle. The inventive wheel adjustment system 10 provides an advantage over prior art go-kart wheel adjustment systems by laterally moving the kingpin 20 relative to the frame 4, thereby maintaining a constant relationship between the kingpin 20 and the tire/wheel assembly 8.

It can be seen that the left steering adjustment system 10a is a mirror image of the right steering adjustment system 10b, consequently only one version, the right steering adjustment system 10b, will be illustrated and discussed in the remaining figures and description.

FIG. 3C is a graphic representation of adjustments that are easily made with the inventive wheel adjustment system 10. There are three orthogonal axes: the lateral-horizontal axis H, the longitudinal-horizontal axis L, and the vertical axis V. Directions are defined for a wheel adjustment system 10 (e.g., 10b) that is mounted on the right side of the frame 4. Therefore, the lateral-horizontal axis H has its origin where the wheel adjustment system 10 is adjusted to place the kingpin 20 as close to the side of the frame 4 as possible, and increases (positive) to the right, i.e., laterally outward from the side of the frame 4. The longitudinal-horizontal axis L is parallel to the longitudinal direction (straight-ahead path of the go-kart 2), and increases (positive) in the forward direction into the page, and decreases (negative) in the aft direction out of the page. The vertical axis V increases (positive) in the upward direction. It should be noted that wheel adjustment system 10 is specifically designed such that it's adjustments can be made without affecting vertical positioning of the kingpin 20, unlike prior art systems such as the one described in the Pearce patent discussed hereinabove.

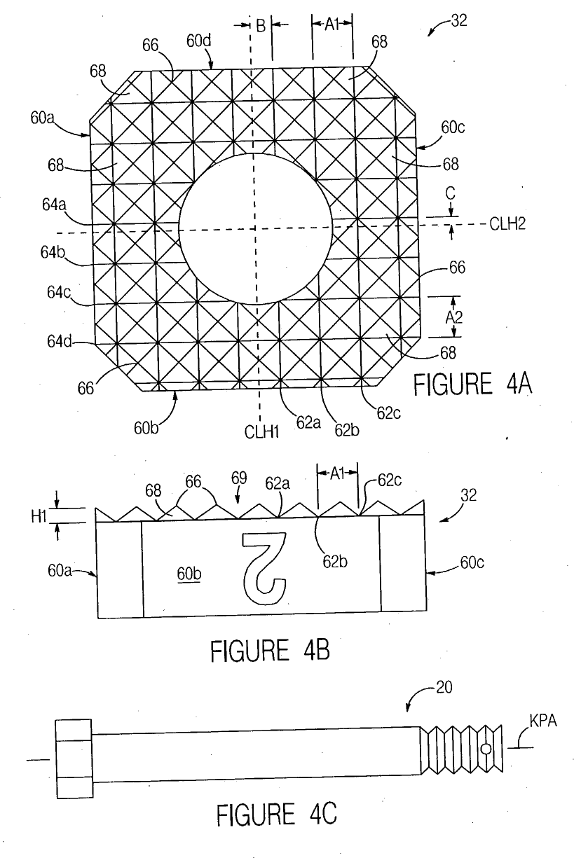

An exemplary position of the kingpin 20 is indicated in FIG. 3C by a line KPA that represents a kingpin axis KPA, i.e., the axis of revolution of the kingpin 20 (see FIGS. 3B and 4C). A length of the kingpin axis KPA is shown for a kingpin 20 that has been adjusted to a desired caster and camber. The origin of the three axes V, L, H is conveniently placed on the kingpin axis KPA. A caster angle CS is the angle measured between the vertical axis V and a line VL-PROJ that is a projection of the kingpin axis KPA onto a plane containing the vertical axis V and the longitudinal-horizontal axis L. According to the definition of caster, the illustrated caster angle CS is a negative angle since the top of the kingpin axis KPA is rotated forward. A camber angle CM is the angle measured between the vertical axis V and a line VH-PROJ that is a projection of the kingpin axis KPA onto a plane containing the vertical axis V and the lateral-horizontal axis L. According to the definition of camber, the illustrated camber angle CM is a positive angle since the top of the kingpin axis KPA is rotated outward. As discussed hereinabove, this representation of camber assumes that the kingpin 20 is parallel to the tire/wheel assembly 8, since camber is properly defined as the tilt of the tire/wheel assembly 8. Thus, if there is a preset camber due to a non-orthogonal spindle to kingpin hub angle φ, then the preset camber (90°−φ) must be added to the angle CS in order to determine the true camber of the tire/wheel assembly 8 mounted on the wheel adjustment system 10.

In addition to independently adjusting camber and caster, the wheel adjustment system 10 also enables independent adjustment of longitudinal position (fore or aft movement of the kingpin axis KPA along the longitudinal-horizontal axis L), and of lateral position (movement of the kingpin axis KPA along the lateral-horizontal axis H inward or outward relative to the side of the frame 4).

Overview of the Assembled Wheel Adjustment System

FIGS. 3A and 3B offer two views of a preferred embodiment of the inventive wheel adjustment system 10, assembled and adjusted as desired. FIG. 3A is a top view, and FIG. 3B is a cross-sectional side view taken along the line 3B-3B in FIG. 3A. Separate drawings of the individual component parts are in FIGS. 4A through 10C and will be discussed in detail hereinbelow.

A spindle bracket 22 holds the kingpin 20 about which the kingpin hub 14 rotates. The kingpin 20 is shown tilted outward for a positive camber angle CM that is adjustably held in position by a kingpin nut 30 clamping a camber block 32 against a top arm 72 of the spindle bracket 22. The camber block 32 has pyramids 68 that interlock with serrations 70 on top of the top arm 72, thereby holding the kingpin 20 at a desired camber angle CM.

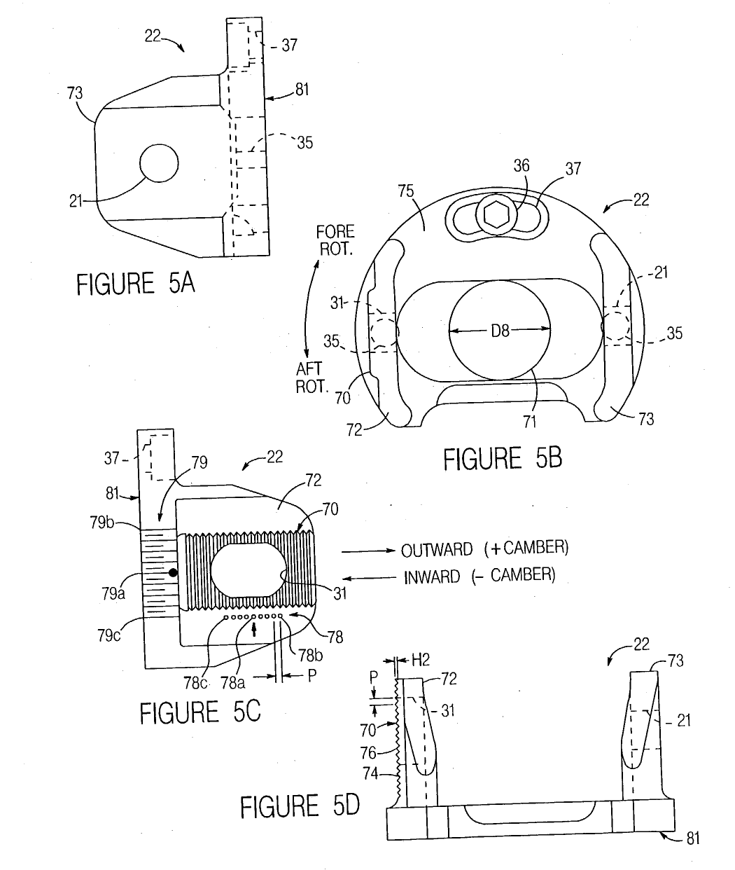

To the left (inward) of the spindle bracket 22 are a track width spacer 24 and a sliding flange 26, which at least partly surround a mounting bar 28 and an adjustment pill 90. After adjustment of caster angle CS, track width TW, and wheelbase WBL, WBR, the spindle bracket 22, the track width spacer 24 and the sliding flange 26 are held together, preventing relative movement, by removable attachment means (e.g., second bolts 34, and first bolt 36 shown in FIG. 5B). After fore-aft adjustment of the wheelbase WBL, WBR, the adjustment pill 90, the sliding flange 26 and the mounting bar 28 are held together, preventing relative movement, by removable attachment means comprising fore-aft securing bolts 38. Finally, the mounting bar 28 is fixedly attached (e.g., welded) to the frame 4 (partly shown in FIG. 3B with a ghost outline), such that a longitudinal axis LA of the mounting bar 28 is parallel to the longitudinal-horizontal axis L.

Component Parts of the Wheel Adjustment System

FIGS. 4A and 4B show a bottom and a side view, respectively, of the camber block 32. The camber block 32 is nominally square, with a kingpin hole 61 through the center of the square. Each of the four sides 60 are labeled with a stamped number: number “1” on a first side 60a, number “2” on a second side 60b, number “3” on a third side 60c, and number “4” on a fourth side 60d. A first centerline CLH1 is shown extending orthogonally between the second side 60b and the fourth side 60d, passing through an axis of rotation of the kingpin hole 61. A second centerline CLH2 is shown extending orthogonally between the first side 60a and the third side 60c, passing through the axis of rotation of the kingpin hole 61. A bottom surface 69 of the camber block 32 has an orderly array of pyramids 68 that interlock with the serrations 70 on top of the top arm 72. The four-sided pyramids 68 are formed on two sides by triangular first camber block valleys 62 (e.g., 62a, 62b, 62c) that are formed parallel to the first centerline CLH1, regularly spaced apart with a first valley pitch A1. Importantly, a first camber block valley 62a that is closest to the first centerline CLH1 is spaced away by a first offset B. The four-sided pyramids 68 are formed on the other two sides by triangular second camber block valleys 64 (e.g., 64a, 64b, 64c, 64d) that are formed parallel to the second centerline CLH2, regularly spaced apart with a second valley pitch A2. Importantly, a second camber block valley 64a that is closest to the second centerline CLH2 is spaced away by a second offset C, importantly having a different dimension than the first offset B. To enable interlocking of the pyramids 68 with the serrations 70, the first valley pitch A1 and the second valley pitch A2 are equal to each other and also equal to a serration pitch P as best seen in FIG. 5D. Likewise, a pyramid height H1 is equal to a serration height H2 as best seen in FIG. 5D. Because the first valley pitch A1 is equal to the second valley pitch A2, the pyramids 68 are symmetrically shaped and their peaks 66 are spaced apart by the same pitch A1, A2, P dimension. The functioning of the camber block 32 will be described hereinbelow after a description of the spindle bracket 22, with which it interacts.

FIGS. 5A, 5B, 5C, and 5D (FIGS. 5A-5D) show views of the bottom, outward side, top, and aft side, respectively, of the spindle bracket 22. A bottom arm 73 is pierced by a round kingpin pivot hole 21. A flat spindle bracket inward side surface 81 extends into the page in the views of FIGS. 5A and 5C. Two blind threaded holes 35 open out through the spindle bracket inward side surface 81 and are shown in FIGS. 5A and 5B with phantom outlines inside the bottom arm 73 and a top arm 72. A caster pivot hole 71 has an inside diameter D8 and passes through a mounting plate 75 portion of the spindle bracket. At least a portion of the periphery of the mounting plate 75 is circular and has a radius of curvature centered at the center of the caster pivot hole 71. An arcuate oblong recessed caster adjustment hole 37 also passes through the mounting plate 75 and receives a first bolt 36, using the recessed portion to receive the head of the first bolt 36.

The top arm 72 has an oblong camber adjustment hole 31 dimensioned to receive the kingpin 20 and to allow camber adjustment by tilting the kingpin 20 inward (negative camber) or outward (positive camber) throughout a range determined by the extent of the long axis of the oblong camber adjustment hole 31. Surrounding the camber adjustment hole 31 is a triangular sawtooth pattern of camber adjustment serrations 70 comprising regularly spaced, parallel peaks 76 and valleys 74 that extend orthogonally to the long axis of the oblong camber adjustment hole 31. The camber adjustment serrations 70 have a pitch P and valley-to-peak height H2. The peaks 76 that cross the camber adjustment hole 31 are marked by nine camber locating dots 78 (e.g., 78a, 78b, 78c), of which the central camber locating dot 78a is marked with an arrow. The pitch P is dimensioned such that tilting the kingpin 20 from a peak 76 to an adjacent peak 76 produces a one degree change of lateral kingpin inclination, which corresponds to the change of camber angle CM. Aligning the kingpin axis KPA with the central camber locating dot 78a produces zero degrees camber angle CM, so tilting the kingpin 20 from an outermost camber locating dot 78b to an innermost camber locating dot 78c produces a range of camber angles CM from +4° to −4°, respectively.

On the round perimeter of the mounting plate 75, a regularly spaced pattern of 17 parallel caster locating lines 79 (e.g., 79a, 79b, 79c) are inscribed. The central caster locating line 79a is marked with a dot, and is located in line with the center of the camber adjustment hole 31. Referring also to FIG. 3A, it can be noted that an assembled wheel adjustment system 10 has a caster alignment groove 49, 59 inscribed in the perimeter of system components (track width spacer 24 and/or sliding flange 26, respectively) that will be adjacent to the spindle bracket 22. When caster is adjusted, the track width spacer 24 and/or sliding flange 26 will remain fixed while the spindle bracket 22 is rotated about the caster pivot hole 71, thereby causing the caster alignment groove 49, 59 to point to different ones of the caster locating lines 79 to indicate the caster angle CS. The caster locating lines 79 are spaced such that each one represents a one degree change in caster angle CS of the kingpin 20. Rotating the spindle bracket 22 to align the central caster locating line 79a with the caster alignment groove 49, 59 produces zero degrees caster angle CS, so a range of caster angles CS from +8° to −8° can be selected. Rotating the spindle bracket 22 in an aft rotation direction (AFT ROT.) to align a forwardmost caster locating line 79b with the caster alignment groove 49, 59 produces +8° caster angle CS, and rotating the spindle bracket 22 in an forward rotation direction (FORE ROT.) to align an aftmost caster locating line 79c with the caster alignment groove 49, 59 produces −8° caster angle CS. It can be seen that the kingpin 20, which is held in the camber adjustment hole 31 and the kingpin pivot hole 21, will rotate to the selected caster angle CS along with the spindle bracket 22.

The center of curvature of the arcuate caster adjustment hole 37 is coincident with the center of the caster pivot hole 71 and has an arc length such that when the first bolt 36 is loosened, the spindle bracket 22 can rotate about the caster pivot hole 71 to any selected caster angle CS. Therefore, the first bolt 36 and the caster adjustment hole 37 are positioned such that the first bolt 36 is located in the center of the arc length of the arcuate caster adjustment hole 37 when the central caster locating line 79a is aligned with the caster alignment groove 49, 59 to produce a 0° caster angle CS. Furthermore, it will be seen from the following description that similar arcuate caster adjustment holes (45, 55) are provided for second bolts 34 that screw into the threaded holes 35.

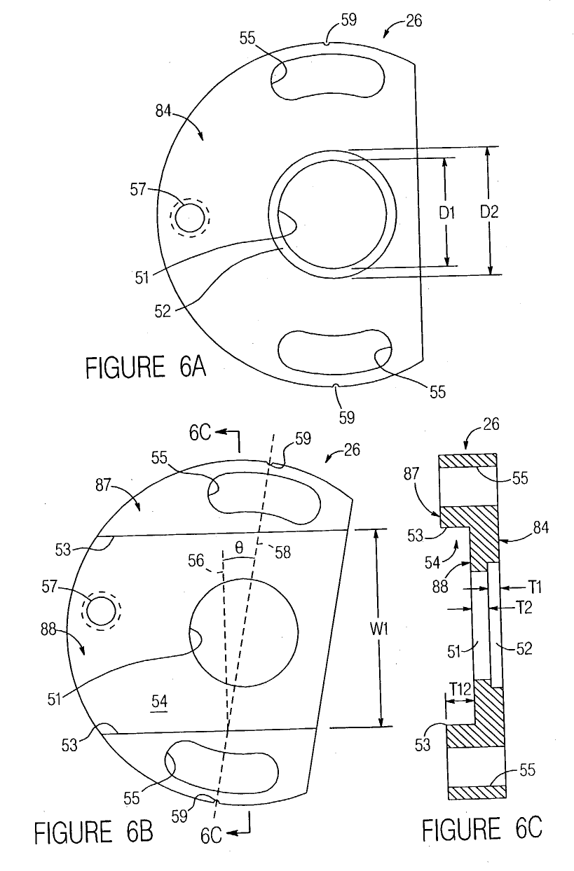

FIGS. 6A, 6B, and 6C (FIGS. 6A-6C) show views of the outward side, inward side, and cross-section along the line 6C-6C, respectfully, of the sliding flange 26. The sliding flange 26 is preferably shaped and sized to correspond to the overall shape and dimensions of the spindle bracket mounting plate 75. An outward side surface 84 is suitably flat for positioning against, and rotatingly sliding on, the spindle bracket inward side surface 81. A pill receiving hole 51 has an inside diameter D1 and passes through the sliding flange 26. At least a portion of the periphery of the sliding flange 26 is circular and has a radius of curvature centered at the center of the pill receiving hole 51, therefore the periphery of the sliding flange 26 will align with the periphery of the spindle bracket mounting plate 75 when the center of the pill receiving hole 51 is aligned with the center of the caster pivot hole 71. Coaxial with the pill receiving hole 51, a recess 52 having a diameter D2 and thickness/depth Ti is cut into the outward side surface 84. Two arcuate oblong caster adjustment holes 55 also pass through the sliding flange 26, and are sized and positioned suitably to receive the second bolts 34 (see FIG. 3B) that screw into the spindle bracket threaded holes 35. The centers of curvature of the arcuate caster adjustment holes 55 are coincident with the center of the pill receiving hole 51 and have an arc length such that when the second bolts 34 are loosened, the spindle bracket 22 can rotate about the pill receiving hole 51 and caster pivot hole 71 to any selected caster angle CS. Also passing through the sliding flange 26 is a threaded hole 57 suitably sized and positioned to allow the first bolt 36 to be screwed into it after passing through the caster adjustment hole 37, and through track width spacer through holes 47 if present.

A shallow caster alignment groove 59, perpendicular to the outward side surface 84, is cut into the periphery of the sliding flange 26 at the same rotational angles as the centers of the arc length of the arcuate caster adjustment holes 55. Therefore, when the second bolts 34 are screwed into the spindle bracket threaded holes 35 and are located in the center of the arc length of the arcuate caster adjustment hole 55, the spindle bracket central caster locating line 79a is aligned with the caster alignment groove 59 to indicate a 0° caster angle CS.

A square U-shaped channel 54, having parallel sides 53 at a width W1 is cut to a uniform thickness/depth T12 across an inward side surface 87 of the sliding flange 26, thereby creating a channel inward side surface 88. A preset caster angle θ is the acute angle between a reference line 56 that is perpendicular to the sides 53 of the channel 54, and a diametrical reference line that passes between the two caster alignment grooves 59. The caster preset angle θ represents a preset magnitude for the caster angle CS because when the wheel adjustment system 10 is assembled and mounted on the frame 4 as seen in FIG. 3B, the channel 54 will be oriented for enabling horizontal longitudinal (fore-aft) adjustment. Therefore the channel sides 53 will be horizontal, making the perpendicular reference line 56 vertical and indicative of 0° caster angle CS. Simply rotating the cutting location for the channel 54 relative to the caster adjustment holes 55 and their correspondingly positioned caster alignment grooves 59 will produce any desired preset caster angle θ magnitude, including zero for no preset in the caster angle CS.

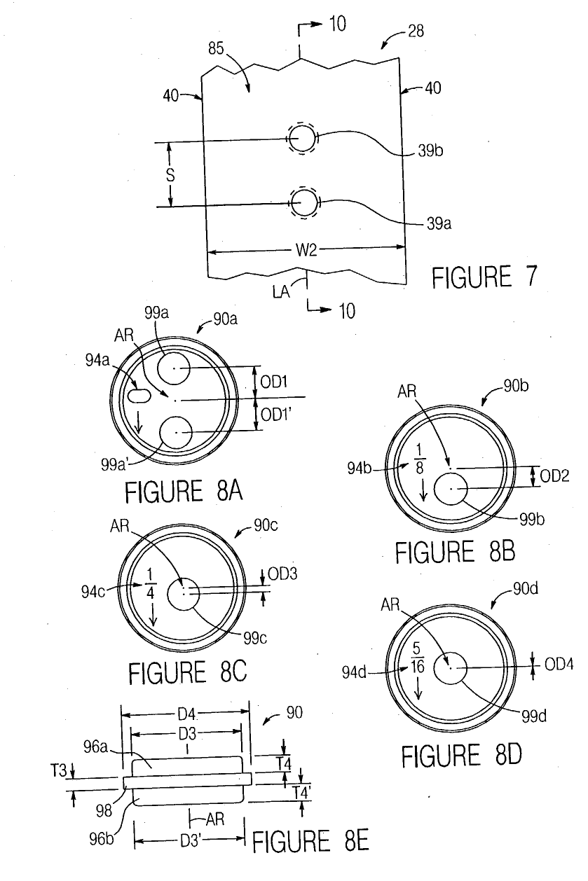

FIG. 7 shows an outward surface of the mounting bar 28. The mounting bar 28 is an arbitrarily long, relatively thin bar that is rectangular in cross-section (best seen in FIG. 3B) having a thickness T10 (shown in FIG. 3A) measured between an outward side surface 85 and an inward side surface 86, and having a width W2 measured between parallel sides 40. When adjusting the wheel base WBL, WBR, one slides the sliding flange 26 (attached to the spindle bracket 22) forward or aft along the mounting bar 28 for a desired adjustment distance. The mounting bar 28 length along its longitudinal axis LA (parallel to the sides 40), is determined by the available space on the go-kart frame 4 combined with the desired amount of fore-aft (wheel base WBL, WBR) adjustment range. One or more, but preferably two, threaded holes 39 (e.g., a forward hole 39a and an aft hole 39b) are regularly spaced along the longitudinal axis LA with a hole spacing S.

FIGS. 8A, 8B, 8C, and 8D show outward sides of four embodiments of an adjustment pill 90a, 90b, 90c, and 90d, respectively (collectively referred to as adjustment pills 90). FIG. 8E shows a generic top view of the adjustment pills 90. Each adjustment pill 90 is circular about an axis of revolution AR, and has a circular collar 98 with a collar thickness T3 and a collar diameter D4. On one side of the collar 98 is an outward portion 96a with a thickness T4 and diameter D3. The outside diameter D3 is slightly less than the inside diameter D8 of the caster pivot hole 71 in the spindle bracket 22, such that the adjustment pill 90 fits in the caster pivot hole 71 thereby allowing rotation of the spindle bracket 22 about the adjustment pill axis of revolution AR. On the other side of the collar 98 is an inward portion 96b with a thickness T4′ and diameter D3′, wherein the diameter D3′ is significantly less than the collar diameter D4. In order to enable securely fitting the adjustment pill 90 into the sliding flange 26, the outside diameter D3′ is slightly less than the inside diameter D1 of the sliding flange pill receiving hole 51; the collar diameter D4 is slightly less than the inside diameter D2 of the sliding flange recess 52; the collar thickness T3 is slightly less than the sliding flange recess thickness/depth Ti; and the inward portion thickness T4′ is slightly less than the sliding flange pill receiving hole thickness/depth T2.

Using a method that will be described hereinbelow, the adjustment pills 90 are used to select different increments of fore-aft adjustment for the wheel adjustment system 10. One or two through holes 99 are positioned at different locations on different adjustment pills 90 to facilitate the fore-aft adjustment. Four embodiments of the adjustment pills 90 will be described as examples of the many adjustment pill 90 variations encompassed by the scope of the present invention. For example, FIG. 8A shows a “0” adjustment pill 90a having an appropriate pill label 94a stamped thereupon. The “0” adjustment pill 90a has an axis of revolution AR illustrated as an imaginary dot. Two through holes 99a, 99a′ are provided on diametrically opposed sides of the axis of revolution AR; a first through hole 99a being centered at an offset distance OD1 from the axis of revolution AR, and a second through hole 99a′ being centered at an offset distance OD1′ from the axis of revolution AR. Although the “0” adjustment pill 90a uses equal magnitude offset distances OD1 and OD1′, it is within the scope of the invention to have other adjustment pills 90 with two or more through holes 99, each having different offset distances, and each being on a different diametrical line. In the preferred embodiment of the invention, the offset distances OD1, OD1′ are both 5/16″ (inch) so that the first through hole 99a is spaced apart from the second through hole 99a′ by a distance of ⅝″, which matches the mounting bar hole spacing S.

In a second example, FIG. 8B shows a “⅛” adjustment pill 90b having an appropriate pill label 94b stamped thereupon. The “⅛” adjustment pill 90b has an axis of revolution AR illustrated as an imaginary dot. One through hole 99b is provided and is centered at an offset distance OD2 from the axis of revolution AR. In the preferred embodiment of the invention, the offset distance OD2 is 3/16″.

In a third example, FIG. 8C shows a “¼” adjustment pill 90c having an appropriate pill label 94c stamped thereupon. The “¼” adjustment pill 90c has an axis of revolution AR illustrated as an imaginary dot. One through hole 99c is provided and is centered at an offset distance OD3 from the axis of revolution AR. In the preferred embodiment of the invention, the offset distance OD3 is 1/16″.

In a fourth example, FIG. 8D shows a “5/16” adjustment pill 90d having an appropriate pill label 94d stamped thereupon. The “5/16” adjustment pill 90d has an axis of revolution AR illustrated as an imaginary dot. One through hole 99d is provided and is centered at an offset distance OD4 from the axis of revolution AR. In the preferred embodiment of the invention, the offset distance OD3 is zero inches, i.e., the through hole 99d is positioned in the diametrical center of the adjustment pill 90d.

Adjustment pill offset distances such as offset distances OD1, OD1′, OD2, OD3, OD4 may be generically referred to as an offset distance OD.

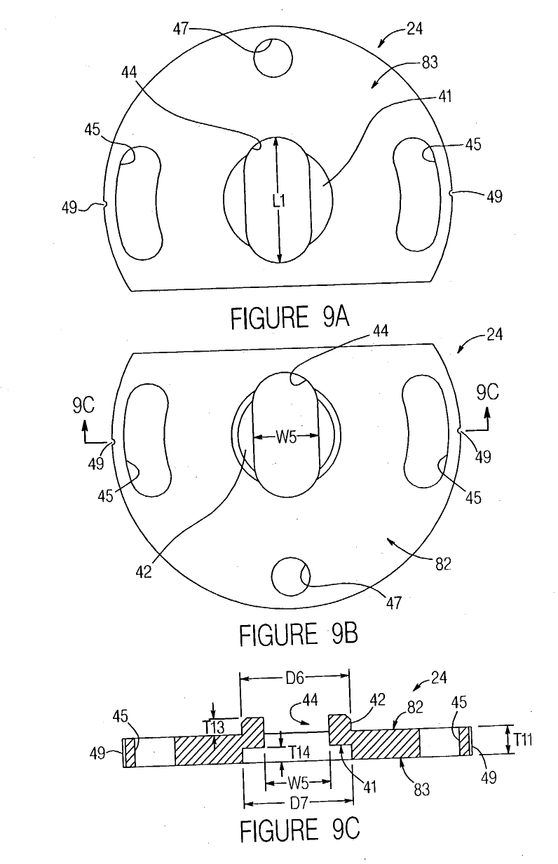

FIGS. 9A, 9B, and 9C (FIGS. 6A-6C) show views of the inward side, outward side, and cross-section along the line 9C-9C, respectfully, of the track width spacer 24. The track width spacer 24 is preferably shaped and sized to correspond to the overall shape and dimensions of the spindle bracket mounting plate 75. An outward side surface 82 is suitably flat for positioning against, and rotatingly sliding on, the spindle bracket inward side surface 81. A protruding hub 42 protrudes from the center of the outward side surface 82 and is sized and positioned to rotatingly fit into the spindle bracket caster pivot hole 71. Therefore the protruding hub 42 has a thickness/height T13 that is approximately the same as the adjustment pill outward portion thickness T4, and an outside diameter D6 that is slightly less than the inside diameter D8 of the caster pivot hole 71. At least a portion of the periphery of the track width spacer 24 is circular and has a radius of curvature centered at the diametrical center of the protruding hub 42, therefore the periphery of the track width spacer 24 will align with the periphery of the spindle bracket mounting plate 75 when the protruding hub 42 is positioned in the caster pivot hole 71.

Coaxial with the protruding hub 42, a recess 41 having an inside diameter D7 and a thickness/depth T14 is cut into an inward side surface 83. The diameter D7 is slightly greater than the adjustment pill outward portion diameter D3, and the thickness/depth T14 is at least as thick as the adjustment pill outward portion thickness T4, such that the adjustment pill outward portion 96a will fit into the recess 41 when the track width spacer inward side surface 83 is positioned against the outward side surface 84 of the sliding flange 26 when it has an adjustment pill 90 received within the sliding flange pill receiving hole 51. It should be noted that the above-described dimensions of the track width spacer 24 enable multiple track width spacers 24 to be stacked between the spindle bracket 22 and the sliding flange 26, since the protruding hub 42 of a first track width spacer 24 will fit within the recess 41 of a second track width spacer 24.

Two arcuate oblong caster adjustment holes 45 also pass through the track width spacer 24, and are sized and positioned suitably to receive the second bolts 34 (see FIG. 3B) that screw into the spindle bracket threaded holes 35. The centers of curvature of the arcuate caster adjustment holes 45 are coincident with the center of the protruding hub 42 and have an arc length such that when the second bolts 34 are loosened, the spindle bracket 22 can rotate about the protruding hub 42 and caster pivot hole 71 to any selected caster angle CS.

A shallow caster alignment groove 49, perpendicular to the outward and inward side surfaces 82, 83, is cut into the periphery of the track width spacer 24 at the same rotational angles as the centers of the arc length of the arcuate caster adjustment holes 45. Therefore, when the second bolts 34 are screwed into the spindle bracket threaded holes 35 and are located in the center of the arc length of the arcuate caster adjustment hole 45, the spindle bracket central caster locating line 79a is aligned with the caster alignment groove 49 to indicate a 0° caster angle CS.

Also passing through the track width spacer 24 is a through hole 47 suitably sized and positioned to allow the first bolt 36 to pass through it after passing through the caster adjustment hole 37, and thence to be screwed into the sliding flange threaded hole 57. The through hole 47 is positioned to be aligned with the sliding flange threaded hole 57 when the caster alignment groove 49 is aligned with the sliding flange caster alignment groove 59.

An oblong clearance hole 44 is optionally centered on the protruding hub 42 to provide clearance for the heads of the fore-aft securing bolts 38 if they protrude outward from the adjustment pill 90 as illustrated, for example, in FIG. 3B. Of course the clearance hole 44 would not be needed if the fore-aft securing bolts 38 are recessed in the adjustment pill 90. The optional clearance hole 44 has a long-axis length L1 and a width W5 that are sized to accommodate protruding heads of two fore-aft securing bolts 38 securing the two-hole “0” adjustment pill 90a. Since the length L1 dimension is oriented orthogonally to a line between the caster alignment grooves 49, 59 (e.g., line 58 in FIG. 6B), the width W5 is greater than the width of the fore-aft securing bolt 38 heads in order to accommodate any rotation of the adjustment pill 90 brought about by a non-zero preset caster angle θ.

The preferred embodiment track width spacer 24 has a thickness/height T11 of 0.25″ (1/4 inch) for combination with adjustment pill outward portion thickness T4, track width spacer recess thickness/depth T14, and track width spacer protruding hub thickness/height T13 that all equal 0.125″ (1/8 inch). It is obviously within the scope of the invention to maintain the same T4, T14, T13 dimensions while increasing the track width spacer thickness/height T11 (to 3/8 inch, for example). In order to permit a smaller first increment in track width TW, the T4, T14, T13 dimensions could be reduced commensurate with any reduction in the track width spacer thickness/height T11.

Assembly and Operation

In light of the foregoing detailed description of the component parts of the wheel adjustment system 10, and with particular reference to FIGS. 3A and 3B, the assemblage of the component parts will now be described along with explanation of how the parts interact to provide the versatile adjustment features of the present invention.

The spindle bracket 22 holds the kingpin 20 about which the kingpin hub 14 rotates in response to steering input. The kingpin 20 is adjustably held in position by a kingpin nut 30 clamping the camber block 32 against the top arm 72 of the spindle bracket 22. The camber block pyramids 68 interlock with the serrations 70 on top of the top arm 72. The line of camber locating dots 78 is used to gauge the amount of camber by comparing the dots to the centerline (the kingpin axis KPA) of the kingpin 20. To aid this process, the camber block kingpin hole centerlines CLH1, CLH2 are preferably indicated by marks on each side 60 of the camber block 32. An oblong camber adjustment hole 31 allows the kingpin 20 to be tilted (inclined) in a range of angles from negative to positive camber, with the kingpin 20 pivoting in the kingpin pivot hole 21 located in the bottom arm 73 of the spindle bracket 22.

To adjust camber, the kingpin nut 30 is loosened enough to allow the camber block 32 to be moved relative to the spindle bracket serrations 70. The serration pitch P matches the camber block pitches A1, A2, and the pitch P, A1, A2 is dimensioned such that laterally moving the camber block 32 from interlocking with one serration peak 76 to a next adjacent serration peak 76 allows one degree of camber angle CM. The wheel adjustment system 10 additionally enables fractional degree camber angle CM changes because the camber block valleys 62, 64 are offset from the center of the camber block kingpin hole 61 by offsets B, C that are different fractions of the pitch P, A1, A2. An example of the way this works is as follows: interlocking the camber block 32 with the serrations 70 when the camber block 32 is rotated to have the first side 60a (labeled “1”) facing the camber locating dots 78 could align the kingpin axis KPA with, for example, the central camber locating dot 78a for a 0° camber angle CM. Laterally moving the camber block 32 outward to interlock with the next adjacent serration peak 76 will align the kingpin axis KPA with the next camber locating dot 78, thereby moving a whole degree to yield a +1° camber angle CM. However, if the camber block 32 is rotated a quarter turn to have the second side 60b (labeled “2”) facing the camber locating dots 78, then the camber block 32 can be interlocked with the serrations 70 in a way that will move the kingpin axis KPA a first fraction F1 of the distance to the next camber locating dot 78, thereby moving a first fraction F1 of a degree to yield a +F1° camber angle CM. If the camber block 32 is rotated to have the third side 60c (labeled “3”) facing the camber locating dots 78, then the camber block 32 can be interlocked with the serrations 70 in a way that will move the kingpin axis KPA a second fraction F2 of the distance to the next camber locating dot 78, thereby moving a second fraction F2 of a degree to yield a +F2° camber angle CM. Finally, if the camber block 32 is rotated to have the fourth side 60d (labeled “4”) facing the camber locating dots 78, then the camber block 32 can be interlocked with the serrations 70 in a way that will move the kingpin axis KPA a third fraction F3 of the distance to the next camber locating dot 78, thereby moving a third fraction F3 of a degree to yield a +F3° camber angle CM.

To the left (inward) of the spindle bracket 22 are a track width spacer 24 and a sliding flange 26, which at least partly surround a mounting bar 28 and an adjustment pill 90. After adjustment, the spindle bracket 22, the track width spacer 24 and the sliding flange 26 are held together, preventing relative movement, by removable attachment means comprising second bolts 34 (passing through the holes 55 and 45 into the threaded holes 35 in the spindle bracket 22), and by a first bolt 36 (passing through the holes 37 and 47 into the threaded hole 57 in the sliding flange 26). Independent adjustment of track width TW is accomplished by positioning a selected quantity of track width spacers 24 between the spindle bracket 22 and the sliding flange 26. The track width spacers 24 may have different thicknesses T11, yielding a wide variety of selectable discrete increases in track width TW. For example, selecting from a plurality of track width spacers 24 having a first track width spacer thickness T11 of 0.25″ (1/4 inch) allows track width TW increases from zero increase (no track width spacers 24 selected), to 0.25″, 0.50″, 0.75″, and so on. Selecting from a plurality of track width spacers 24 that include some with a first track width spacer thickness T11 of 0.25″ and others with a second track width spacer thickness T11 of 0.375″ (3/8 inch) allows track width TW increases from zero increase (no track width spacers 24 selected), to 0.250″, 0.375″, 0.500″, 0.625″, 0.750″, and so on. First bolts 36 and second bolts 34 need to be provided in different lengths to accommodate the larger track width TW increases. As noted hereinabove, the track width spacers 24 are nest-able and do not interfere with the other adjustment capabilities of the wheel adjustment system 10. It may also be noted that the first bolt 36 passing through the track width spacer through hole 47 prevents rotation of the track width spacer 24 relative to the sliding flange 26, thereby keeping the track width spacer caster alignment groove 49 in line with the sliding flange caster alignment groove 59.

After fore-aft adjustment of the wheelbase WBL, WBR, the adjustment pill 90, the sliding flange 26 and the mounting bar 28 are held together, preventing relative movement, by removable attachment means comprising fore-aft securing bolts 38 passing through the adjustment pill holes 99 into the threaded holes 39 in the mounting bar 28. The fore-aft securing bolts 38 hold the adjustment pill 90, and the collar 98 on the adjustment pill 90 holds the sliding flange 26. The mounting bar 28 is fixedly attached (e.g., welded) to the frame 4 (partly shown in FIG. 3B with a ghost outline), such that the longitudinal axis LA of the mounting bar 28 is parallel to the longitudinal-horizontal axis L. The sliding flange 26 is positioned so that the square U-shaped channel 54 slidingly receives the mounting bar 28, i.e., the mounting bar outward side surface 85 is against the channel inward side surface 88, and the mounting bar sides 40 are slidingly engaged with the channel sides 53. Thus the interaction of the mounting bar sides 40 and the channel sides 53 prevent all rotational and translational movement of the wheel adjustment system 10 except for for-aft sliding when fore-aft adjustments are being made.

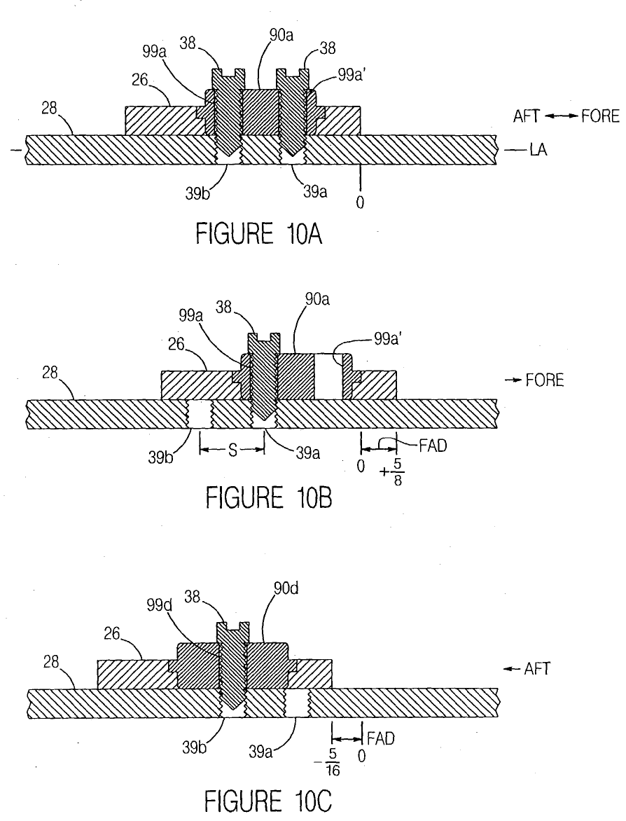

FIGS. 10A, 10B, and 10C (FIGS. 10A-10C) provide three examples that illustrate the inventive method of fore-aft (wheelbase WBL, WBR) adjustment provided by the wheel adjustment system 10. The FIGS. 10A-10C are each a cross-sectional view taken along the line 10-10 in FIG. 7, wherein the sliding flange 26 is held in a selected fore-aft position by a selected adjustment pill 90 and fore-aft securing bolts 38 that pass through selected ones of the through holes 99 and then are screwed into selected ones of the threaded holes 39. The forward (fore) longitudinal direction is shown as being toward the right, and the aftward (aft) direction is shown as being toward the left. For these examples, the preferred embodiment dimensions are utilized, therefore the threaded hole spacing S is ⅝″.

In FIG. 10A, the “0” adjustment pill 90a is selected, and two fore-aft securing bolts 38 are used, such that one bolt 38 passes through the first through hole 99a and is selectively screwed into the aft threaded hole 39b, and a second bolt 38 passes through the second through hole 99a′ and is selectively screwed into the forward threaded hole 39a. Although not seen in this view, FIG. 8A shows that the pill label 94a includes a forward-indicating arrow pointing from the first through hole 99a to the second through hole 99a′. The fore-aft position selected by the assembly shown in FIG. 10A is designated as the zero position, corresponding to a wheelbase WBL, WBR that is in the middle of the fore-aft adjustment range for the go-kart 2. The actual magnitude of the mid-range wheelbase is determined by the fore-aft position of the mounting bar threaded holes 39 when the mounting bar 28 is fixedly attached (e.g., welded) to the frame 4 of the go-kart 2. If more than two regularly spaced mounting bar threaded holes 39 are provided to increase the range of fore-aft adjustment, then it will be necessary to indicate the proper pair of threaded holes 39 to use for a zero position.

FIG. 10B shows the effect of selecting the same “0” adjustment pill 90a, but selectively passing one bolt 38 through the first through hole 99a and selectively screwing it into the forward threaded hole 39a. The zero position is indicated in the FIGS. 10A-10C by a mark labeled “0” that is aligned with a leading edge of the sliding flange 26 when it is in the zero position as shown in FIG. 10A. In FIG. 10B, a new mark labeled “+⅝” is aligned with the leading edge and the distance between the two marks is the fore-aft adjustment distance FAD. Since the first through hole 99a has been moved forward from the aft threaded hole 39b to the forward threaded hole 39a, the fore-aft adjustment distance FAD is equal to the hole spacing S, or ⅝″. This fore-aft adjustment distance FAD is a positive number because the adjustment pill 90 has been moved in the forward or positive direction. A fully assembled wheel adjustment system 10 would be attached to the adjustment pill 90, therefore the entire wheel adjustment system 10 would be adjusted forward ⅝″ from the zero position.

FIG. 10C shows the effect of selecting the “5/16” adjustment pill 90d, passing one bolt 38 through the through hole 99d and selectively screwing it into the aft threaded hole 39b. A new mark labeled “−5/16” is aligned with the leading edge, thereby determining a new magnitude for the fore-aft adjustment distance FAD. Comparing FIGS. 10A and 8A to FIGS. 10C and 8D, it can be seen that, relative to the bolt 38 screwed into the aft threaded hole 39b, the adjustment pill 90a has been moved 5/16″ aftward in order to effectively position the first through hole 99a in the center of the adjustment pill 90d. Thus the new fore-aft adjustment distance FAD in FIG. 10C has the magnitude of the “0” pill first offset distance OD1 which is half of the hole spacing S, or −5/16″. This fore-aft adjustment distance FAD is a negative number because the adjustment pill 90 has been moved in the aft or negative direction.

Continuing the above fore-aft adjustment process using the four exemplary adjustment pills 90a, 90b, 90c, and 90d with two threaded holes 39 in the mounting bar 28 produces the following table of fore-aft adjustment distance FAD values. Obviously this method can be extended to provide many more selectable fore-aft adjustment distance FAD values by using variations in the number of threaded holes 39 and by using other adjustment pills 90 having different offset distances for the through holes 99.

| Adjustment Pill | Pill Hole | FAD when use | FAD when use |
|---|---|---|---|
| Used | Used | aft threaded hole | forward threaded hole |
| “0” | both | 0 | 0 |
| “0” | aft | 0 | +5/8 |
| “0” | fore | −5/8 | 0 |
| “1/8” | fore | −4/8 | +1/8 |
| “1/8” | aft | −1/8 | +4/8 |
| “1/4” | fore | −3/8 | +2/8 |
| “1/4” | aft | −2/8 | +3/8 |
| “5/16” | (centered) | −5/16 | +5/16 |

An outward portion 96a of the adjustment pill 90 has a circular (round) perimeter that fits into a circular recess 41 in the track width spacer 24, and the track width spacer 24 has a protruding hub 42 with a circular perimeter that fits into a circular caster pivot hole 71 in the spindle bracket 22. Track width adjustment is accomplished by positioning a selected number (e.g., 0, 1, 2, etc.) of track width spacers 24 between the spindle bracket 22 and the sliding flange 26, so the track width spacers 24, the adjustment pill 90, and the spindle bracket 22 must be stackable. Therefore, the outside diameter D3 and the thickness T4 of the outward portion 96a of the adjustment pill 90 correspondingly mate with the inside diameter D7 and the thickness/depth T14 of the recess 41 of the track width spacer 24, and also mate with the inside diameter D8 of the caster pivot hole 71 of the spindle bracket 22. Similarly, the outside diameter D6 and the thickness/height T13 of the protruding hub 42 correspondingly mate with the inside diameter D7 and the thickness/depth T14 of the recess 41, and also mate with the inside diameter D8 of the caster pivot hole 71. A thickness for the caster pivot hole 71 need not be specified since it is an open ended hole, not a recess.

Independent caster adjustment is enabled by the circular nature of the above-described mating components. In particular, loosening the first bolt 36 and the second bolts 34 allows the spindle bracket 22 to be rotated to a desired caster angle CS as indicated by the position of caster locating lines 79 on the spindle bracket 22 relative to a caster alignment groove 49 appropriately located on the side of the track width spacer 24, and/or relative to a caster alignment groove 59 appropriately located on the side of the sliding flange 26. During caster adjustment, the caster pivot hole 71 rotates around the protruding hub 42 if a track width spacer 24 is present, or around the outward portion 96a of the adjustment pill 90 if a track width spacer 24 is not present.

All variations of the dimensions discussed herein are intended to be included in the scope of the invention. An important set of dimensional variations that may not be obvious will now be described as an alternate embodiment of the invention.

Referring to FIGS. 6A and 8E, the sliding flange pill receiving hole diameter D1 can be reduced to a magnitude d1 that is less than the magnitude of the adjustment pill outward portion diameter D3. Correspondingly, the adjustment pill lower portion diameter D3′ can be reduced to a magnitude that is equal to the new magnitude d1 of the pill receiving hole diameter D1. Then the sliding flange recess 52 can be effectively eliminated by reducing the magnitude of its diameter D2 to be equal to the new magnitude d1 of the pill receiving hole diameter D1. Correspondingly, the adjustment pill collar 98 can be effectively moved outward by reducing the magnitude of its diameter D4 to be equal to the magnitude of the outward portion diameter D3, and then by subtracting the magnitude of the collar thickness T3 from the magnitude of the outward portion thickness T4 and simultaneously adding the magnitude of the collar thickness T3 to the inward portion thickness T4′. Thus the complexity and expense of manufacturing the sliding flange 26 and the adjustment pills 90 are reduced, while maintaining the inventive concept of using the adjustment pill collar 98 to hold the sliding flange 26 against the mounting bar 28 when the adjustment pill 90 is bolted to the mounting bar 28.

Although the invention has been illustrated and described in detail in the drawings and foregoing description, the same is to be considered as illustrative and not restrictive in character—it being understood that only preferred embodiments have been shown and described, and that all changes and modifications that come within the spirit of the invention are desired to be protected. Undoubtedly, many other “variations” on the “themes” set forth hereinabove will occur to one having ordinary skill in the art to which the present invention most nearly pertains, and such variations are intended to be within the scope of the invention, as disclosed herein.

What is claimed is:

1. A wheel adjustment system for a go-kart having a kingpin about which a wheel steeringly rotates in response to steering input, the wheel adjustment system comprising:
a mounting bar fixedly attached to a frame of the go-kart such that a longitudinal axis of the mounting bar is oriented in a fore-aft direction relative to the frame;
a kingpin holder comprising a spindle bracket for holding the kingpin, and a sliding flange for slidably engaging with the mounting bar;
one or more openings regularly spaced along the longitudinal axis of the mounting bar;
at least one through hole longitudinally spaced by offset distances along the sliding flange; and
fore-aft securing elements extending through selected ones of the at least one through hole and into selected ones of the one or more openings for attaching the spindle bracket to the frame with a selected fore-aft adjustment distance.

2. The wheel adjustment system of claim 1, further comprising:
a square U-shaped, inward opening channel on the sliding flange;
an inward facing first surface on the spindle bracket mating with a corresponding outward facing second surface on the sliding flange;
a circular caster pivot hole in the first surface, and a circular pill receiving hole in the second surface;
an adjustment pill that fits into the pill receiving hole and rotatingly fits into the caster pivot hole when the first surface and the second surface are held together, for allowing only rotational movement of the spindle bracket relative to the sliding flange; and
removable attachment means for holding the first surface and the second surface together; wherein:
the at least one through holes are in the adjustment pill such that each of the at least one through holes is parallel to an axis of revolution of the adjustment pill, and is offset from the axis of revolution by an offset distance;
the openings are threaded holes; and
the fore-aft securing elements are bolts that pass through the through holes and screw into the threaded holes.

3. The wheel adjustment system of claim 2, further comprising:
two through holes having equal offset distances on diametrically opposing sides of the axis of revolution.

4. The wheel adjustment system of claim 3, wherein:
the threaded holes are regularly spaced at twice the equal offset distance.

5. The wheel adjustment system of claim 2, further comprising:
a plurality of adjustment pills, each having a different offset distance.

6. The wheel adjustment system of claim 2, further comprising:
a collar around the adjustment pill for holding the sliding flange to the mounting bar.

7. The wheel adjustment system of claim 2, further comprising:
a plurality of track width spacers selectable for providing selected discrete increases in track width when a selected quantity of the plurality of track width spacers is positioned between the first surface and the second surface, wherein each one of the plurality of track width spacers comprises:
an outward facing third surface that mates with the first surface;
an inward facing fourth surface that mates with the second surface;
in the fourth surface, a circular recess dimensioned such that the adjustment pill fits therein; and
on the third surface, a protruding hub that rotatingly fits into the caster pivot hole.

8. The wheel adjustment system of claim 2, wherein:
the removable attachment means comprises attachment bolts that screw into either the spindle bracket or the sliding flange; and
arcuate oblong through holes for the attachment bolts are provided for allowing the spindle bracket to rotate about the caster pivot hole to adjust a caster angle.

9. The wheel adjustment system of claim 8, wherein camber adjustment components are provided comprising:
a top arm of the spindle bracket comprising: an oblong camber adjustment hole for tiltingly receiving the kingpin, and serrations regularly spaced with a pitch on top of the top arm around the camber adjustment hole;
a nominally square camber block comprising: four sides, a bottom surface having an orderly array of four-sided pyramids that interlock with the serrations, and a central kingpin hole for receiving the kingpin; such that:
the pyramids are defined by a first set of parallel valleys that cross orthogonally from a first camber block side to an opposing third camber block side, and by a second set of parallel valleys that cross orthogonally from a second camber block side to an opposing fourth camber block side;
the first set of parallel valleys is offset from a center of the kingpin hole by a first offset distance that is a first fraction of the pitch;
the second set of parallel valleys is offset from the center of the kingpin hole by a second offset distance that is a second fraction of the pitch; and
the second offset distance has a different magnitude than the first offset distance for enabling a different increment of camber angle adjustment when each of the four camber block sides is turned to face aftward.

10. A wheel adjustment system for a go-kart having a kingpin about which a wheel steeringly rotates in response to steering input, the wheel adjustment system comprising:
a sliding flange attached to a frame of the go-kart;
a spindle bracket for holding the kingpin;
an inward facing first surface on the spindle bracket mating with a corresponding outward facing second surface on the sliding flange;
a plurality of track width spacers, each comprising: an outward facing third surface that mates with the first surface; and an inward facing fourth surface that mates with the second surface; and
removable attachment means for holding together the sliding flange, a selected quantity of the plurality of track width spacers, and the spindle bracket; such that:
the selected quantity of the plurality of track width spacers can be positioned between the first surface and the second surface for providing selected discrete increases in track width while maintaining the position of the kingpin in relationship to the wheel.

11. The wheel adjustment system of claim 10, further comprising:
a circular caster pivot hole in the first surface, and a circular pill receiving hole in the second surface;
an adjustment pill that fits into the pill receiving hole and rotatingly fits into the caster pivot hole when the first surface and the second surface are held together, for allowing only rotational movement of the spindle bracket relative to the sliding flange;
in the fourth surface, a circular recess dimensioned such that the adjustment pill fits therein; and
on the third surface, a protruding hub that rotatingly fits into the caster pivot hole.

12. The wheel adjustment system of claim 11, further comprising:
a mounting bar fixedly attached to a frame of the go-kart such that a longitudinal axis of the mounting bar is oriented in a fore-aft direction relative to the frame;
a square U-shaped channel in the sliding flange, the channel opening inward for slidably engaging with the mounting bar, thereby providing attachment of the sliding flange to the frame;
at least one through hole in the adjustment pill wherein each of the at least one through holes is parallel to an axis of revolution of the adjustment pill, and is offset from the axis of revolution by an offset distance;
one or more threaded holes regularly spaced along the longitudinal axis of the mounting bar; and
fore-aft securing bolts for passing through selected ones of the at least one through holes and for screwing into selected ones of the one or more threaded holes, thereby attaching the spindle bracket to the frame with a selected fore-aft adjustment distance.

13. The wheel adjustment system of claim 11, further comprising:
two through holes having equal offset distances on diametrically opposing sides of the axis of revolution.

14. The wheel adjustment system of claim 13, wherein:
the threaded holes are regularly spaced at twice the equal offset distance.

15. The wheel adjustment system of claim 11, further comprising:
a plurality of adjustment pills, each having a different offset distance.

16. The wheel adjustment system of claim 11, further comprising:
a collar around the adjustment pill for holding the sliding flange to the mounting bar.

17. The wheel adjustment system of claim 11, wherein:
the removable attachment means comprises attachment bolts that screw into either the spindle bracket or the sliding flange; and
arcuate oblong through holes for the attachment bolts are provided for allowing the spindle bracket to rotate about the caster pivot hole to adjust a caster angle.

18. The wheel adjustment system of claim 17, wherein camber adjustment components are provided comprising:
a top arm of the spindle bracket comprising: an oblong camber adjustment hole for tiltingly receiving the kingpin, and serrations regularly spaced with a pitch on top of the top arm around the camber adjustment hole;
a nominally square camber block comprising: four sides, a bottom surface having an orderly array of four-sided pyramids that interlock with the serrations, and a central kingpin hole for receiving the kingpin; such that:
the pyramids are defined by a first set of parallel valleys that cross orthogonally from a first camber block side to an opposing third camber block side, and by a second set of parallel valleys that cross orthogonally from a second camber block side to an opposing fourth camber block side;
the first set of parallel valleys is offset from a center of the kingpin hole by a first offset distance that is a first fraction of the pitch;
the second set of parallel valleys is offset from the center of the kingpin hole by a second offset distance that is a second fraction of the pitch; and
the second offset distance has a different magnitude than the first offset distance for enabling a different increment of camber angle adjustment when each of the four camber block sides is turned to face aftward.

19. A wheel adjustment system for a go-kart having a kingpin about which a wheel steeringly rotates in response to steering input, the wheel adjustment system comprising:
a mounting bar fixedly attached to a frame of the go-kart such that a longitudinal axis of the mounting bar is oriented in a fore-aft direction relative to the frame;
a sliding flange for slidably engaging with the mounting bar;
a spindle bracket for pivotably holding a kingpin, thereby enabling camber adjustment by selectively pivoting the kingpin in the spindle bracket;
an inward facing first surface on the spindle bracket mating with a corresponding outward facing second surface on the sliding flange;
a circular caster pivot hole in the first surface;
a circular protruding hub on the second surface that rotatingly fits into the caster pivot hole when the first surface and the second surface are held together, for allowing only rotational movement of the spindle bracket relative to the sliding flange, thereby enabling caster adjustment;
removable attachment means for holding the first surface and the second surface together;
at least one through hole longitudinally spaced by offset distances along the sliding flange;
one or more openings regularly spaced along the longitudinal axis of the mounting bar;
fore-aft securing elements extending through selected ones of the at least one through hole and into selected ones of the one or more openings for attaching the spindle bracket to the frame with a selected fore-aft adjustment distance; and
a plurality of track width spacers for providing selected discrete increases in track width when a selected quantity of the plurality of track width spacers is positioned between the first surface and the second surface for providing selected discrete increases in track width while maintaining the position of the kingpin in relationship to the wheel.

20. The wheel adjustment system of claim 19, wherein:
the sliding flange has a square U-shaped, inward opening channel for slidably engaging with the mounting bar;
the circular protruding hub on the second surface is an adjustment pill that fits into a circular pill receiving hole provided in the second surface, and that rotatingly fits into the caster pivot hole when the first surface and the second surface are held together;
the at least one through holes are formed in the adjustment pill wherein each of the at least one through holes is parallel to an axis of revolution of the adjustment pill, and is offset from the axis of revolution by an offset distance;
each one of the plurality of track width spacers comprises: an outward facing third surface that rotatingly mates with the first surface; and an inward facing fourth surface that mates with the second surface;
a circular recess dimensioned such that the adjustment pill fits therein is provided in the fourth surface;
a protruding hub that rotatingly fits into the caster pivot hole is provided on the third surface;
the openings are threaded holes; and
the fore-aft securing elements are bolts that pass through the through holes and screw into the threaded holes.

21. The wheel adjustment system of claim 20, wherein:
the removable attachment means comprises attachment bolts that screw into either the spindle bracket or the sliding flange; and
arcuate oblong through holes for the attachment bolts are provided for allowing the spindle bracket to rotate about the caster pivot hole to adjust a caster angle.

22. The wheel adjustment system of claim 21, wherein camber adjustment components are provided comprising:
a top arm of the spindle bracket comprising: an oblong camber adjustment hole for tiltingly receiving the kingpin, and serrations regularly spaced with a pitch on top of the top arm around the camber adjustment hole;
a nominally square camber block comprising: four sides, a bottom surface having an orderly array of four-sided pyramids that interlock with the serrations, and a central kingpin hole for receiving the kingpin; such that:
the pyramids are defined by a first set of parallel valleys that cross orthogonally from a first camber block side to an opposing third camber block side, and by a second set of parallel valleys that cross orthogonally from a second camber block side to an opposing fourth camber block side;
the first set of parallel valleys is offset from a center of the kingpin hole by a first offset distance that is a first fraction of the pitch;
the second set of parallel valleys is offset from the center of the kingpin hole by a second offset distance that is a second fraction of the pitch; and
the second offset distance has a different magnitude than the first offset distance for enabling a different increment of camber angle adjustment when each of the four camber block sides is turned to face aftward.

23. The wheel adjustment system of claim 20, further comprising:
two through holes having equal offset distances on diametrically opposing sides of the axis of revolution.

24. The wheel adjustment system of claim 23, wherein:
the threaded holes are regularly spaced at twice the equal offset distance.

25. The wheel adjustment system of claim 20, further comprising:
a plurality of adjustment pills, each having a different offset distance.

26. The wheel adjustment system of claim 20, further comprising:
a collar around the adjustment pill for holding the sliding flange to the mounting bar.

27. Method for independently adjusting camber, caster, fore-aft position and lateral position of a go-kart steered wheel while maintaining a position of a kingpin in relationship to the steered wheel, wherein the steered wheel is rotatingly mounted on a nominally horizontal spindle that rotates about a nominally vertical kingpin in response to steering input, and wherein the kingpin is adjustably mounted in a spindle bracket that is adjustably attached to a frame of the go-kart; the method comprising the steps of:
adjusting camber by selectively pivoting the kingpin in the spindle bracket;
fixedly attaching a mounting bar to a frame of the go-kart such that a longitudinal axis of the mounting bar is oriented in a fore-aft direction relative to the frame;
providing a sliding flange 26 for slidably engaging with the mounting bar;
mating an inward facing first surface on the spindle bracket with a corresponding outward facing second surface on the sliding flange;
allowing only rotational movement of the spindle bracket relative to the sliding flange by providing a circular caster pivot hole in the first surface, and a circular protruding hub on the second surface that rotatingly fits into the caster pivot hole when the first surface and the second surface are held together, thereby enabling caster adjustment;
holding the first surface and the second surface together with removable attachment means;
regularly spacing one or more openings along the longitudinal axis of the mounting bar;
providing at least one through hole spaced by offset distances along the channel;
attaching the spindle bracket to the frame with a selected fore-aft adjustment distance by passing fore-aft securing elements through selected ones of the at least one through holes, and then securing the fore-aft securing elements into selected ones of the one or more openings; and
selecting discrete increases in track width by positioning a selected quantity of track width spacers between the first surface and the second surface, wherein the track width spacer comprises: an outward facing third surface that rotatingly mates with the first surface; and an inward facing fourth surface that mates with the second surface.

28. The method of claim 27, further comprising the steps of:
providing a square U-shaped, inward opening channel in the sliding flange for slidably engaging with the mounting bar;
forming the circular protruding hub on the second surface by providing an adjustment pill that fits into a circular pill receiving hole provided in the second surface, and that rotatingly fits into the caster pivot hole when the first surface and the second surface are held together;
forming the at least one through holes in the adjustment pill wherein each of the at least one through holes is parallel to an axis of revolution of the adjustment pill, and is offset from the axis of revolution by an offset distance;
in the fourth surface, providing a circular recess dimensioned such that the adjustment pill fits therein;
on the third surface, providing a protruding hub that rotatingly fits into the caster pivot hole;
providing threaded holes for the openings; and
for the fore-aft securing elements, providing bolts that pass through the through holes and screw into the threaded holes.

29. The method of claim 28, further comprising the steps of:
providing the removable attachment means by screwing attachment bolts into either the spindle bracket or the sliding flange; and
forming arcuate oblong through holes for the attachment bolts thereby allowing the spindle bracket to rotate about the caster pivot hole to adjust a caster angle.

30. The method of claim 29, further comprising steps for adjusting camber angle, including the steps of:
providing a top arm of the spindle bracket comprising: an oblong camber adjustment hole for tiltingly receiving the kingpin, and serrations regularly spaced with a pitch on top of the top arm around the camber adjustment hole;
providing a nominally square camber block comprising: four sides, a bottom surface having an orderly array of four-sided pyramids that interlock with the serrations, and a central kingpin hole for receiving the kingpin;
defining the pyramids by a first set of parallel valleys that cross orthogonally from a first camber block side to an opposing third camber block side, and by a second set of parallel valleys that cross orthogonally from a second camber block side to an opposing fourth camber block side;
offsetting the first set of parallel valleys from a center of the kingpin hole by a first offset distance that is a first fraction of the pitch;
offsetting the second set of parallel valleys from the center of the kingpin hole by a second offset distance that is a second fraction of the pitch; and
selecting a magnitude for the second offset distance that is different than the magnitude of the first offset distance, thereby enabling a different increment of camber angle adjustment when each of the four camber block sides is turned to face aftward.
